(19) United States
(12) Patent Application Publication
(10) Pub. No.: US 2007/0171188 A1
(43) Pub. Date: Jul. 26, 2007

(54) Sensor for handheld device control illumination

(76) Inventor: Nigel Waites, Lakeville, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/339,257

(22) Filed: Jan. 25, 2006

(51) Int. Cl. G09G 5/00

(52) U.S. Cl. 345/156

(57) ABSTRACT

The present invention is a sensor for installation within a handheld device, such as a portable media player or a mobile phone, that turns on illumination of controls for the device (graphical user interface, buttons, etc.) while the device is being gripped by a user, and turns off control illumination when the device leaves the hand of the user.

### FIELD OF THE INVENTION

The present invention relates generally to handheld electronic devices. More particularly, it relates to a sensor that illuminates one or more user controls for a handheld device if the device is being held within the hand of a user.

### BACKGROUND OF THE INVENTION

A rich variety of handheld electronic devices are presently available to consumers. These include portable media players, mobile phones, personal digital assistants, remote control units, still and video cameras, handheld computers, calculators, satellite positioning units, and home maintenance tools such as laser levelers. The trend today is to merge selected functional capabilities of existing tool types into new composite device classes. Miniaturization, computerization, the enormous opportunity and intense competition in the consumer electronics marketplace, and a growing awareness of the need for interoperability among electronic devices are also driving the development of ever smaller, yet more complex, handheld devices.

Exemplifying this trend, early mobile phones simply supported the sending and receiving of telephone communications. Within a few short years, hundreds of features have been incorporated into mobile phones, including extensive digital address books, voice mail, call forwarding and call waiting capabilities, alarms, still and video photography, radio reception, games, text messaging, and Internet access.

To provide the user with access to such extensive functionality, handheld devices today must necessarily have a multitude of tiny controls, including buttons, switches, dials, and often a flat panel display delivering a graphical user interface (GUI). A GUI, exploiting computer technology, can provide a nearly limitless and sometimes bewildering hierarchy of on-screen virtual controls (e.g., menus, trees, and buttons). Additionally, a handheld device may have one or more ports or connections for interoperation with other equipment. Connection capability might be provided, for example, for power connections or for wireless, FireWire, or Universal Serial Bus (USB) communications.

Hereinafter, we shall use the term “control” to encompass any component (tangible or visual) designed to allow the user to interact with the device, modifying its state or invoking its functional features. Thus, such handheld device components as connectors, ports, and antennas shall also (i.e., in addition to components more obviously regarded as controls, such as buttons, switches, and GUI controls) be considered controls within the broad sense intended by our use of the word.

To access device features through a GUI, the user must necessarily look at the device. But even if a device such as a television remote control unit utilizes only tangible controls (e.g., buttons), a number of factors conspire to render purely tactile operation relatively difficult-the small size of the typical device, the enormous variety of capabilities, and the lack of standardization of the controls (often even among similar products from a single manufacturer). Moreover, unlike controls that many people learn once for a lifetime to operate solely by physical touch, such as the basic controls for driving a motor vehicle and the buttons of a QWERTY keyboard, the rapid improvement in handheld electronic devices for almost every aspect of life at home and at work causes frequent changes in control configuration. To take advantage of innovation, one must be willing to repeatedly start over in learning how to effectively manipulate device controls.

Thus, whether navigating a GUI or utilizing a complex and not completely familiar handheld device, being able to actually view the controls by eye is critical to operation of the device. For visibility, a GUI must typically be backlighted when in use at any time of day. Tactile controls, such as buttons, must be illuminated to be visible in an environment where ambient lighting is limited. With respect to the need for connector visibility, it perhaps suffices to say that a square peg cannot be put into a round hole.

A handheld device today usually spends at least a phase of its daily life cycle in a wire-free configuration, during which the device is powered by battery. Whether a handheld device is adapted to rechargeable batteries, non-rechargeable batteries, or both, the usefulness of the device when deployed wire-free is constrained by the lifetime of the battery charge. During an interval while the device controls are lighted, a significant drain may be imposed on the battery charge. Most handheld electronic devices, therefore, have control lights that are first illuminated upon the occurrence of an initial triggering event, such as the opening of the cover of a flip phone. Typically, the control lights go off automatically after a fixed interval of time, measured either from the initial triggering event itself or from the most recent control manipulation by the user (e.g., a button press on a cell phone).

This involuntary shutdown of control lighting based upon an arbitrary criterion outside the user's control is inconvenient indeed if, for whatever reason, the user is unable to complete an interaction with the device before the lighting times out. With a cell phone in particular, the user must typically press another key or dose and reopen the phone to make the control lights come back on. Such arbitrary signals to the device, given with the intention of restoring lighting, are usually disruptive of the command that the user had been in the midst of communicating to the device when the control lighting failed. For example, if the lights go out while a user, sitting in the back seat of a dark automobile, is typing a target number into a cell phone, then he might be presented with the choice of starting over (e.g., by closing and reopening the lid) or pressing another number key (which he would then have to figure out how to undo). It is easy to imagine emergency situations in which having the lights of a cell phone remain lit might prevent disaster. On the other hand, continuing to illuminate the controls beyond the time period during which control visibility is needed wastes the battery charge.

In addition to their suboptimal handling of the timing of illumination of controls, prior art devices require that the user initially trigger illumination by means of an affirmative action-the flip of a switch, the press of a button, or the opening of a cover. This step is logically superfluous at best.

### SUMMARY OF THE INVENTION

The present invention is designed to address these problems in the prior art handheld devices regarding illumination of controls; namely, that (1) control lighting turns off automatically at unintended times; (2) control lighting stays on after it is no longer in use, unnecessarily draining the battery charge; (3) triggering the illumination of control lighting requires an affirmative and sometimes superfluous act of the user; and (4) such an affirmative act to initially illuminate, or to re-illuminate the controls in the midst of communicating a command (e.g., entering the digits of a phone number), might result in an undesirable signal being sent to the device.

The present invention is a sensor, which can be incorporated into nearly any handheld device, that illuminates the control lighting while a user holds the device in her hand. The sensor can distinguish a human hand from an inanimate holder, so that the controls do not inappropriately become automatically illuminated when the device rests within, say, a dashboard retainer in a motor vehicle or a docking station connecting the device to a computer or a sound system.

In one embodiment, the sensor includes two regions of electrically conductive material on the surface of the handheld device. The sensor detects a voltage change when a person grips the device, and illuminates the control lights. When the user puts the device down, the sensor detects that as well, turning the control lights off. The sensor exploits the differences in electrical properties between an inanimate holder and a human hand.

In the preferred embodiment, for a handheld device whose shape approximates a rectangular solid, the sensor includes two strips of metal protruding slightly from opposite sides of the device and an electronic detector within the device that can turn illumination of controls on or off depending on whether the device is being held at a given time. In this embodiment, the sensor includes a capacitance switch operated by touch.

In some situations, the user might want the control lights to be illuminated when they are not grasping the device, or unilluminated while they are holding it. For this reason, the device may optionally be equipped with a switch (or a functional equivalent) whereby the user can override the sensor, manually turning the control lights on or off as desired. When a manual override is used to illuminate the lights, the device can be configured to turn the control lights off either after a given interval of inactivity or upon an affirmative signal from the user. Optionally, parameters controlling some or all automated behavior related to illumination of controls may be set by the user.

### BRIEF DESCRIPTION OF THE DRAWINGS

FIG. 1a is a front view of a handheld device equipped with the sensor of the present invention.

FIG. 1b is a top view of a handheld device equipped with the sensor of the present invention, shown when a human hand is gripping the device.

FIG. 2 is a schematic of an embodiment of an electrical circuit implementing the invention.

### DETAILED DESCRIPTION OF THE INVENTION

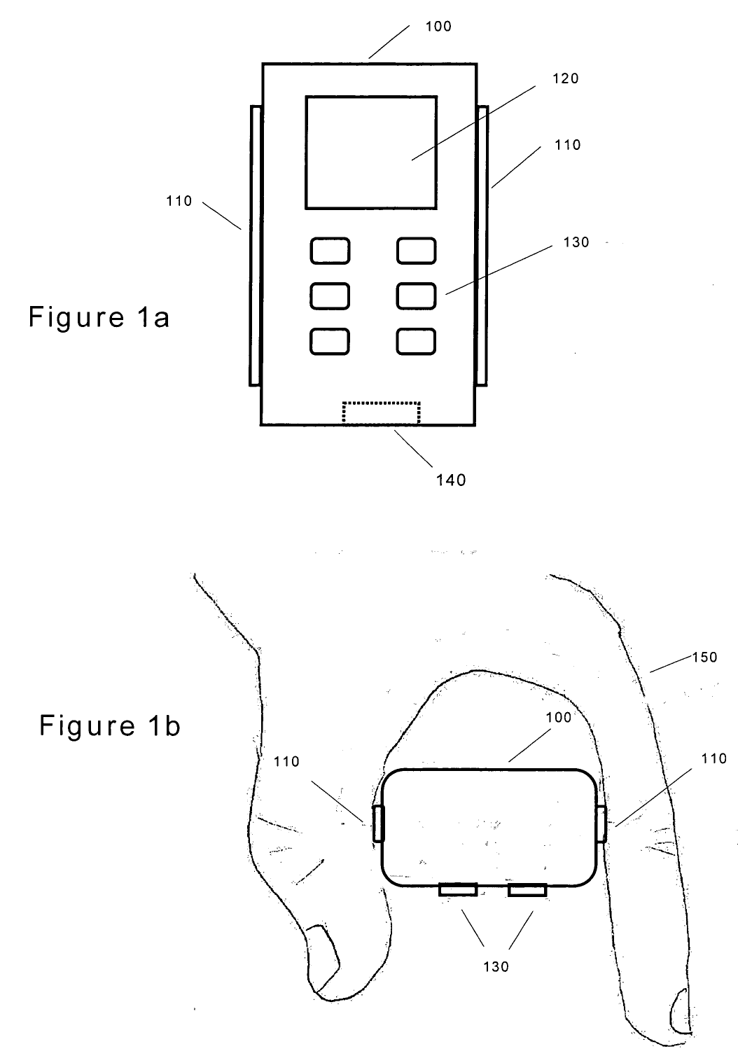

FIG. 1a shows a front view of an illustrative handheld device 100 equipped with the sensor of the present invention. A typical handheld device 100, such as a mobile phone or a portable media player, will have a variety of controls to provide the user with an interface to the functionality of the device. The particular device of FIG. 1a has a flat panel screen 120 to provide a graphical user interface (GUI), and several buttons 130 (a typical one is labeled). A handheld device 100 may have one or more ports or connectors 140 to allow the user to connect the device to other equipment. In the figure, the bottom of the device 100 has a dashed line, indicating a recess to hold a port for a connector 140. The invention is not limited to a device having the shape or including the particular kinds of controls illustrated by FIG. 1a.

The present invention consists of a sensor that can be incorporated into most types of handheld devices 100 and that can (1) detect when the device 100 is being held and (2) distinguish the grasp of a human from that of an inanimate holder. In one embodiment, the sensor consists of two touch zones 110 on the surface of the device 100, connected internally within the device by an electrical circuit 200. The circuit 200 senses when a human hand is in contact with the two touch zones 110, causing one or more lamps 210 within the device to illuminate one or more controls, connectors, or other components. For example, in a portable media player or a mobile phone, the backlight 210 for a flat panel screen 120 would be illuminated, as well as possibly selected switches or buttons.

In the preferred configuration of the external touch zones 110 shown in FUG. 1a, the sensor includes two metal strips 110 embedded within, and projecting slightly out from opposite side surfaces of the device 100. The top view of the handheld device 100 shown in FIG. 1b illustrates that when the device 100 is held, the user's hand 150 will be in contact with both sensor strips 110. Requiring that the sensor detect at least two points of contact avoids many instances of inadvertently lighting the controls when the user is merely manipulating the device 100 but not wanting to interact with the controls.

Other embodiments of the invention might contain a single touch zone 110, or many touch zones 110. Also, the shape of a touch zone 110 need not be rectangular. The essence of the invention is that the sensor turns on the control illumination when a designated form of human contact with the sensor is established and maintained.

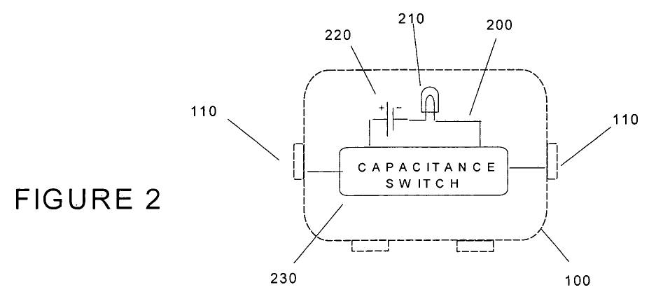

FIG. 2 is a schematic showing the essential elements of an electrical circuit 200 implementing the sensor. The top view of the handheld device 100 corresponding to FIG. 1b is outlined with a dashed line. The sensor is powered by a battery 220 and contains a lamp 210 for illuminating user controls. A capacitance switch 230 connects the circuit to the touch zones 110. The capacitance switch 230 can detect changes over time in voltage at the touch zones 110, and can be configured to close the circuit 200 when the device is being held by a human hand 150. While the circuit is dosed, the lamp 210 will remain illuminated. No net current flows through the body of the user. When the user releases the device 100, the lamp 210 will go out.

In an actual implementation, one or more lights 210 would be arranged to illuminate GUI screens, buttons, and other controls, connectors, and components as desired. For example, a GUI in a flat panel screen 120 might be illuminated by a backlight.

Under some circumstances, it might be desirable for the controls to be illuminated even when the user is not holding the device 100 or, conversely, to be dimmed when the device 100 is being held. The device 100 can optionally incorporate one or more switches to suppress automation of control lighting and dimming. Such switches might be of any kind, such as a buttons, toggles, or voice operated switches.

The present invention is not limited to all the above details, as modifications and variations may be made without departing from the intent or scope of the invention. Consequently, the invention should be limited only by the following claims and equivalent constructions.

What is claimed is:

1. A handheld device, comprising:
a) a control;
b) a lighting apparatus, which when illuminated increases the visibility of the control to a user; and
c) a sensor that causes the lighting apparatus to become illuminated when a user grips the device, and to become unilluminated when the user releases the device.

2. The handheld device of claim 1, wherein the control is a tactile control, a screen, a graphical user interface, a visual control displayed through a graphical user interface, a port, a connector, or an antenna.

3. The handheld device of claim 1, wherein the sensor includes a conductive region exposed on the surface of the device, such that when the hand of a user makes contact with the conductive region, an electrical circuit through the device is dosed, thereby enabling the sensor to detect whether the device is being held by a user.

4. The handheld device of claim 1, wherein the sensor includes two conductive regions exposed on the surface of the device, such that when the hand of a user makes contact with both conductive regions simultaneously, an electrical circuit through the device is dosed, thereby enabling the sensor to detect whether the device is being held by a user.

5. The handheld device of claim 4, wherein each conductive region includes an exposed metal strip.

6. The handheld device of claim 4, wherein each conductive region is raised relative to the respective adjacent outside surface of the device.

7. The handheld device of claim 1, wherein the sensor detects changes in voltage in an exposed touch zone to determine whether the device is being held by a user.

8. The handheld device of claim 7, wherein the sensor includes a capacitance-operated switch.

9. The handheld device of claim 1, wherein the lighting apparatus is a backlight for a flat panel display.

10. The handheld device of claim 1, wherein the device has the functionality of at least one of the set consisting of: a media player, a telephone, a camera, a camcorder, a remote control unit, a personal organizer, a calculator, a computer, a geographic positioning unit, a home maintenance tool, and a construction tool.

11. The handheld device of claim 1, further comprising:
d) an override switch that disables the sensor from automatically operating the lighting apparatus.

12. The handheld device of claim 11, wherein the override switch is a pressure-operated toggle switch or button, or a voice-operated switch.

13. A method for illuminating a user control for a handheld device, comprising:
a) sensing whether the device is being held within a hand of a user;
b) illuminating the control when the device is being held within a hand of a user; and
c) turning off illumination of the control when the device is not being held within a hand of the user.

14. The method of claim 13, wherein turning off illumination does not occur within a previously specified amount of time after the device has been held in the hand of a user.
